(19) United States
(12) Patent Application Publication
(10) Pub. No.: US 2026/0336393 A1
(43) Pub. Date: Oct. 29, 2026

(54) ALL-WHEEL DRIVE VEHICLE

(71) Applicant: AUDI AG, Ingolstadt (DE)

(72) Inventors: Alfred REHR, Hepberg (DE); Alfred SANGL, Mindelstetten-Hiendorf (DE)

(73) Assignee: AUDI AG, Ingolstadt (DE)

(21) Appl. No.: 19/120,423

(22) PCT Filed: Oct. 6, 2023
(86) PCT No.: PCT/EP2023/077681

§ 371 Date: Apr. 11, 2025

(30) Foreign Application Priority Data
Oct. 12, 2022 (DE) 10 2022 126 427.0

(51) Int. Cl. B60K 17/346; B60K 1/00; B60K 17/02

(52) U.S. Cl. CPC B60K 17/3462; B60K 1/00; B60K 17/02

(57) ABSTRACT

An all-wheel drive vehicle may include a drivetrain which has precisely one electric machine which, in a front-wheel drive, only drives the front axle of the vehicle. The electric machine is couplable via a center differential and a center clutch to a cardan shaft, which is couplable in terms of drive to rear wheels of the vehicle via a rear axle differential and via propeller shafts. The rear axle is decoupled from the drivetrain when the center clutch is open and the rear axle is couplable to the drivetrain when the center clutch is closed. In an example, a rear axle separating clutch is installed in one of the propeller shafts of the rear axle.

### CROSS-REFERENCE TO RELATED APPLICATIONS

This application is a U.S. national stage of International Application No. PCT/EP2023/077681, filed on Oct. 6, 2023, which claims the priority benefit of German Patent Application No. 10 2022 126 427.0 filed on Oct. 12, 2022. Both the International Application and the German Patent Application are incorporated by reference herein in their entirety.

### BACKGROUND

### 1. Field

An invention relates to an all-wheel drive, two-track vehicle according to described examples.

### 2. Description of the Related Art

In an all-wheel drive vehicle, the all-wheel drive can be realized with a total of four electric machines, with each electric machine being assigned as a wheel hub motor to a vehicle wheel. In this case, the vehicle manages without differentials. Alternatively, an all-wheel drive can be realized with an electric machine assigned to the front axle and an electric machine assigned to the rear axle, which electric machines each drive the vehicle wheels via a front axle differential and via a rear axle differential. There are also concepts with an electric machine and a locking differential on the front axle and two electric machines on the rear axle, each of which drives a rear wheel. In addition, drives having an internal combustion engine and torque distribution by means of three locking differentials are known from off-road vehicles.

An all-wheel drive vehicle of the type in question has a connectable all-wheel drive, in which the drivetrain has an electric machine. In the front-wheel drive, the electric machine only drives the front axle of the vehicle. The electric machine is couplable via a center differential and a center clutch to a cardan shaft, which is connectable in terms of drive to rear wheels of the vehicle via a rear axle differential and via propeller shafts. The rear axle is decoupled from the drivetrain when the center clutch is open and the rear axle is connectable to the drivetrain when the center clutch is closed.

In the case of an electrically powered off-road vehicle with two or more electric machines, there are the following problems: a plurality of electric machines can indeed be readily controlled independently in terms of torque and rotational speed without the need for a mechanical connection between the front and rear axles. However, this means that each electric machine has to provide the torque and power requirements for the connected wheel(s). Since, in the off-road mode, one wheel or one axle is often unable to deliver torque, the respective other drive has to provide the full driving power. This leads to high requirements for each electric machine. In this case, the total power of all of the electric machines often exceeds the requirement of the entire vehicle. In the off-road mode, there is also the risk that individual electric machines will become overloaded and thus torque and power will be reduced. Each electric machine also has to have its own control (positive inverter). Multi-motor drives are therefore very expensive and heavy.

U.S. Pat. No. 5,373,912 A discloses a vehicle drivetrain with an internal combustion engine drive which drives a center differential for power distribution to front and rear axle differentials. DE 103 04 806 A1 discloses an all-wheel drive vehicle with an internal combustion engine which drives a center differential via a transmission. EP 248 582 B1 discloses an all-wheel drive vehicle with a central differential which drives front and rear axle differentials via cardan shafts in order to drive the vehicle wheels.

### SUMMARY

Example objects of the invention according to described examples are to provide an all-wheel drive, two-track vehicle, the functionality of which is increased in comparison to the prior art and which can in particular drive efficiently in the front-wheel drive and/or change to the all-wheel drive while driving under load.

The example objects may be achieved by the features of the present claims. Other developments of the invention according to the examples may be disclosed in the dependent claims.

The invention according to the examples may be based on an all-wheel drive vehicle with a connectable all-wheel drive. The drivetrain of the vehicle may have precisely one electric machine which, in the front-wheel drive, only drives the front axle of the vehicle. The electric machine is couplable via a center differential or an intermediate axle differential and via a center clutch to a cardan shaft. The cardan shaft is connectable in terms of drive to rear wheels of the vehicle via a rear axle differential and via propeller shafts. The rear axle is decoupled from the drivetrain when the center clutch is open. The rear axle is connectable to the drivetrain when the center clutch is closed. In an example, a rear axle separating clutch is installed in one of the propeller shafts of the rear axle. In the front-wheel drive, that is, with the center clutch open, the rear axle separating clutch is opened. In this way, a train section between the center clutch and the rear axle differential, that is, in particular the cardan shaft and the differential cage of the rear axle differential, is immobilized. The compensating gears of the rear axle differential rotate, on the other hand, without load.

In an example, a single-motor drive with a total of three differentials and five clutches may be provided. This arrangement enables the vehicle to operate efficiently in the front-wheel mode, with the cardan shaft and rear angular transmission being fully decoupled. The change to the all-wheel mode (and back) can take place fully automatically while driving under load.

Furthermore, the driving torque on the wheels can be controlled by selective use of the differential locks (off-road mode). In the case of a vehicle having a plurality of electric machines, however, each electric machine has to cover the requirements (torque and power) of the driven wheel(s). The total power is obtained by adding together all of the installed electric machines. This would result in system powers which are far too high.

In the concept according to the examples of the invention, precisely one electric machine is provided, which is configured for the requirements of the entire vehicle. The power requirement in the off-road mode is usually lower. The drive concept is capable of distributing the required driving power continuously to individual wheels. There is no risk of the electric motor overheating.

In the front-wheel drive, the center locking clutch is closed, all the other clutches are open. The right rear wheel (in the figures) drives the compensating gears of the rear axle differential; however, since there is no connection to the left rear wheel, there is no force transmission between the rear angular transmission and the rear wheels. Therefore, the differential housing (i.e., the differential cage), the rear angular transmission, the cardan shaft and the rear clutch half of the center clutch do not rotate.

According to the examples of the invention, the drivetrain may be configured in such a way that a change from the front-wheel drive to the all-wheel drive during the driving mode can be carried out without interruption of tractive force. When changing from the front-wheel drive to the all-wheel drive, the rear axle locking clutch is closed. This accelerates the rear angular transmission, the cardan shaft and the rear clutch half of the center clutch to a rotational speed correlating with the driving speed. Now the rear axle separating clutch is, then the rear axle locking clutch opens and immediately afterwards the center clutch closes (this is only one option, the shift sequence may be changed as desired). The rear axle locking clutch is for example in the form of a multi-plate clutch because it has to provide synchronization. The center clutch and the rear axle separating clutch are dog clutches since they are shifted without load and at a minimal differential speed. A force-fitting connection to the rear axle is now established.

So that rotational speed differences between the front and rear axles can be compensated for in the further process, the center locking clutch opens. This operation may need to be done under load. This is why the center locking clutch may be in the form of a multi-plate clutch. A dog clutch would also be possible, but leads to comfort restrictions.

In the on-road all-wheel mode, it may be typical to close the center locking clutch and the rear axle locking clutch, which are for example in the form of multi-plate clutches, in a slip-controlled manner. The center clutch and the rear axle separating clutch, on the other hand, remain continuously closed, while the front axle locking clutch remains continuously open.

The change from the all-wheel drive to the front-wheel mode occurs when the driving torque is low. The front axle locking clutch and rear axle locking clutch are opened while the center locking clutch is closed; immediately thereafter, the center clutch and rear axle separating clutch open.

The off-road all-wheel mode starts from the on-road all-wheel mode. A front-wheel mode is not envisaged off-road. In order to variably adjust the driving torque to the desired wheel, the front axle locking clutch, center locking clutch and rear axle locking clutch are fully or partially closed. It is convenient here that, for the reasons given above, the center locking clutch and the rear axle locking clutch are for example in the form of multi-plate clutches, as a result of which a controlled off-road mode is made possible.

The front axle locking clutch is for example in the form of a dog clutch for the following reasons: firstly, the front axle locking clutch is closed only in extreme driving situations. In these situations, comfort plays only a minor role. Many off-road vehicles entirely dispense with said clutch. Secondly, unlike the center locking clutch and the rear axle locking clutch, the front axle locking clutch does not have a dual function.

The essential features are emphasized once again in detail below: in one technical implementation, the rear axle differential can be locked via a rear axle locking clutch. In an example, the rear axle locking clutch is realized as a powershiftable multi-plate clutch. When the locking clutch is activated, a differential cage of the rear axle differential is coupled to one of the propeller shafts, specifically so as to form a rear axle differential lock.

As mentioned above, the center clutch is opened in the front-wheel drive. To change from the front-wheel drive to an all-wheel drive with the rear axle connected, the center clutch is closed. The center clutch can be a non-powershiftable dog clutch. Against this background, the two coupling halves of the center clutch have to be operated approximately in synchronism in order to enable load-free shifting. For this purpose, the rear axle locking clutch can act in dual function as a synchronizing clutch, by which, before the center clutch is closed, a synchronizing operation takes place. During the synchronizing operation, the cardan shaft (upright in the front-wheel mode) is accelerated to the vehicle speed. In this way, the coupling half of the center clutch connected to the cardan shaft can be synchronized with the rotational speed of the coupling half connected to the center differential.

After the synchronizing operation has been carried out, during the further course of the process, in an arbitrary shift sequence the center clutch is closed and the rear axle separating clutch is closed. When the center clutch is closed and the rear axle separating clutch is closed, the rear axle locking clutch is opened and/or the center locking clutch is opened.

In an example, the center differential on both of its output sides can have an intermediate shaft leading to the rear of the vehicle to the center clutch and a pinion shaft leading to the front of the vehicle to a front axle differential. The pinion shaft leading to the front axle differential can be connected in terms of drive via the front axle differential and via propeller shafts to front wheels of the front axle. In addition, the center differential can be locked via a center locking clutch. The center locking clutch can be realized as a powershiftable multi-plate clutch. When the locking function is activated, a differential cage of the center differential can be coupled to the drive shaft leading to the front axle differential, specifically so as to form a center differential lock in the all-wheel mode.

The center locking clutch can act in dual function not only as a differential lock. In addition, in the closed state, that is, in the front-wheel drive, the center locking clutch can ensure transmission of driving torque from the center differential to the front axle differential.

In an example, the electric machine is indirectly or directly connected in terms of drive to the center differential. In this case, the electric machine drives a gearwheel formed on the differential cage of the center differential, for example, by interconnecting a manual transmission and/or a countershaft stage.

The front axle differential can furthermore be locked via a front axle locking clutch. In contrast to the center locking clutch and to the rear axle locking clutch, the front axle locking clutch can be realized as a non-powershiftable dog clutch. When the locking function is activated, a differential cage of the front axle differential can be coupled to a propeller shaft, specifically so as to form a front axle differential lock.

With the drivetrain according to the examples of the invention, the vehicle can drive efficiently in the front-wheel drive, while the cardan shaft and optionally an angular transmission connected between the cardan shaft and the rear axle differential are completely decoupled from the drivetrain. The change from the front-wheel drive to the all-wheel drive can take place fully automatically when driving and under load. The same applies to the change from the all-wheel drive to the front-wheel drive. Furthermore, the driving torque on the wheels can be controlled by selective use of the three differential locks. Overall, the invention according to the examples therefore relates to an electric machine drive with three differentials, namely the front axle differential, the rear axle differential and the center differential, and to a total of five clutches, namely the rear axle separating clutch, the rear axle locking clutch, the center clutch, the center locking clutch and the front axle locking clutch.

The front-wheel drive can be activated in an energy-saving efficiency mode of the vehicle. On the other hand, the all-wheel drive can be divided into an on-road mode and into an off-road mode, i.e., off-road driving or road driving.

In the on-road mode, the rear axle locking clutch, which is in the form of a multi-plate clutch, and/or the center locking clutch, which is in the form of a multi-plate clutch, are openable and closable in a slip-controlled manner for adjustment of the driving dynamics. On the other hand, in the on-road mode, the center clutch and the rear axle separating clutch are continuously closed while the front axle locking clutch is open.

The off-road mode can be carried out identically to the on-road mode, except that the front axle locking clutch is closed. The front axle locking clutch (for example, a non-powershiftable dog clutch) can be engaged by the driver before the start of off-road driving (i.e., when not under load).

### BRIEF DESCRIPTION OF DRAWINGS

Examples of the invention are described below with reference to the appended figures, in which:

FIG. 1 shows a schematic illustration of the drivetrain of a two-track motor vehicle with an electric machine longitudinally installed;

FIG. 2 shows a view according to FIG. 1 of a drivetrain with an electric machine installed transversely.

### DESCRIPTION

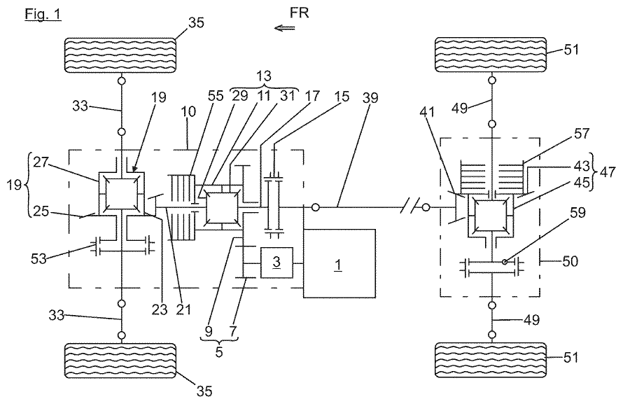

FIG. 1 shows a drivetrain in a two-track vehicle. Accordingly, the drivetrain as the drive unit has an electric machine 1 installed in the longitudinal direction of the vehicle. By way of example, a manual transmission 3 and a spur gear stage 5 for torque conversion are connected downstream of the electric machine 1. The spur gear stage 5 consists of a gearwheel 7 formed on the transmission output shaft of the manual transmission 16 and an input-side gearwheel 9 of a differential cage 11 of a center differential 13. The center differential 13 has, on its two output sides, an intermediate shaft 17 leading to the rear of the vehicle to a center clutch 15 and a pinion shaft 21 leading to the front of the vehicle to a front axle differential 19. According to FIG. 1, the pinion shaft 21 leading to the front of the vehicle is connected in terms of drive via an angular drive 23 to a ring gear 25 of a differential cage of the front axle differential 19.

In the differential cage 13 of the center differential 13, the two shafts 17, 21 are in toothed engagement by way of their axle bevel gears 29 with compensating gears 31, which are rotatably mounted on the differential cage 11.

In FIG. 1, the front axle differential 19 is approximately identical in design to the center differential 13. Accordingly, from the output sides of the front axle differential 19 in the transverse direction of the vehicle, propeller shafts 33 are guided on both sides to the front wheels 35.

The intermediate shaft 17 guided to the rear of the vehicle is connectable in FIG. 1 via the center clutch 15, which is realized in the form of a dog clutch, to a cardan shaft 39, which via an angular drive 41 drives an input-side ring gear 43 of a differential cage 45 of a rear axle differential 47, the construction of which is substantially identical to the construction of the center differential 13. The two output sides of the rear axle differential 47 are connected to the rear wheels 51 via propeller shafts 49.

In addition to the already mentioned center clutch 15, the drivetrain has four further clutches, which are described below. The front axle differential 19 is lockable via a front axle locking clutch 53. The front axle locking clutch 53 is realized as a non-powershiftable dog clutch. When the locking function is activated, the differential cage 27 of the front axle differential 19 is coupled to the left propeller shaft 33, specifically so as to form a front axle differential lock. In the same way, the center differential 13 is also lockable via a center locking clutch 55. The center locking clutch 55 is realized as a powershiftable multi-plate clutch. When the locking function is activated, the center locking clutch 55 couples the differential cage 11 of the center differential 13 to the pinion shaft 21 leading to the front of the vehicle. In the same way, the rear axle differential 47 is also lockable via a rear axle locking clutch 57. The rear axle locking clutch 57 is also realized as a non-powershiftable dog clutch. When the locking function is activated, the rear axle locking clutch 57 couples the differential cage 27 of the front axle differential 19 to the right propeller shaft 49, specifically so as to form a rear axle differential lock. In addition, a rear axle separating clutch 59 is installed in the left propeller shaft 49.

The front axle differential 19, the angular drive 23, the front axle locking clutch 53, the center locking clutch 55, the center differential 13, the center clutch 15, the spur gear stage 5 and the manual transmission 3 are compactly combined in FIG. 1 in a common transmission housing to form a front axle transmission unit 10. The clutches 53, 55, 15 and possibly the manual transmission 3 can be actuated centrally by a shift system, not shown. In the same way, the rear axle differential 47, the rear axle separating clutch 49, the rear axle locking clutch 57 and the angular drive 41 are combined at the rear axle to form a rear axle transmission unit 50.

The vehicle can be operated in the following operating modes: the front-wheel drive is activated in an energy-saving efficiency mode of the vehicle. In the front-wheel drive of the vehicle, only the center locking clutch 55 is closed, while all of the other clutches are open. In this way, the driving torque generated in the electric machine 1 is transmitted via the manual transmission 16, the spur gear stage 5, the differential cage 11 of the center differential 13 to the pinion shaft 21 leading to the front axle differential 19. In the front-wheel drive, owing to the open center clutch 15 and the open rear axle separating clutch 59, a train section between the center clutch 15 and the rear axle differential 47, that is, in particular, the cardan shaft 39, the angular drive 41 and the differential cage 45 of the rear axle differential 47, is immobilized, while the compensating gears in the rear axle differential 47 rotate without load.

The center locking clutch 55 therefore acts in the front-wheel drive in dual function on the one hand for torque transmission and on the other hand as a differential lock during all-wheel drive.

A change from the front-wheel drive to an all-wheel drive with the rear axle connected is carried out as follows: first of all, the rear axle locking clutch 57 is closed. In this way, a synchronizing operation is carried out in which the cardan shaft 39 is accelerated to a rotational speed correlating with the vehicle speed. This causes the coupling half of the center clutch 15 connected to the cardan shaft 39 to be synchronized to the rotational speed of the coupling half which is connected to the drive shaft 17. After the synchronizing operation has been carried out, during the further course of the process, in an arbitrary shift sequence the center clutch 15 is closed and the rear axle separating clutch 59 is closed. When the center clutch 15 is closed and the rear axle separating clutch 59 is closed, the rear axle locking clutch 57 is opened. In order furthermore to be able to compensate for rotational speed differences between the front and rear axles, the center locking clutch 55 is also opened; since this operation takes place under some circumstances under load, the center locking clutch 55 is realized as a multi-plate clutch. Realizing the center locking clutch 55 as a dog clutch, on the other hand, would lead to a loss of comfort.

The all-wheel drive can be divided into an on-road mode and into an off-road mode. In the on-road mode, the rear axle locking clutch 57 and the center locking clutch 55 can be openable and closable in a slip-controlled manner for adjustment of the driving dynamics, while the center clutch 15 and the rear axle separating clutch 59 are continuously closed and the front axle locking clutch 53 is continuously open.

The off-road mode may be identical to the on-road mode, except that the front axle locking clutch 53 is closed without load before the start of the off-road mode. In the closed state, the front axle locking clutch 53 is required only in extreme driving situations in the off-road mode.

With the three locking clutches 53, 55, 57, an off-road functionality can therefore be provided, in which all of the differentials 13, 19 and 47 can be bypassed.

By contrast, in the on-road mode, the differential locks are not required. In this case, it is advantageous, from a driving dynamics aspect, if the center locking clutch 55 and the rear axle locking clutch 57 are opened and/or closed in a slip-controlled manner, as a result of which transmission of torque is controllable to a small extent.

The change from the all-wheel drive to the front-wheel drive is as follows: firstly, the center locking clutch 55 is closed in order to transmit torque from the electric machine 1 to the front axle, with the center differential 13 being bypassed. Then the center clutch 15 and the rear axle separating clutch 59 are opened to immobilize the train section between the center clutch 15 and the rear axle differential 47.

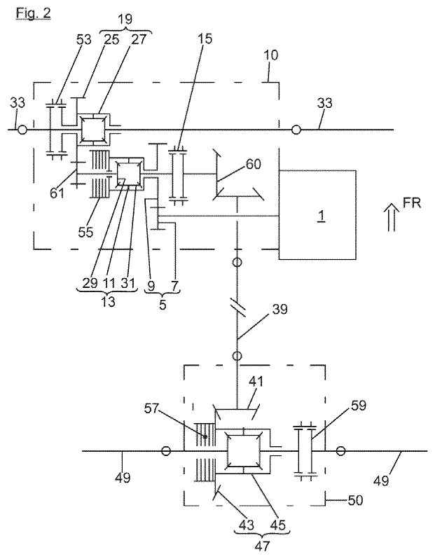

FIG. 2 shows a further example of a drivetrain in a two-track vehicle. The construction and the functionality of the drivetrain are substantially structurally identical to the construction and the functionality of the drivetrain shown in FIG. 1. In contrast to FIG. 1, in FIG. 2, the electric machine 1 and the front-axle transmission unit 10 are not installed longitudinally, but rather are installed in the transverse direction of the vehicle. Another angular drive 61 is connected between the center clutch 15 and the cardan shaft 39. In addition, in contrast to FIG. 1, the drive shaft 21 leading to the front axle does not drive the front axle differential 19 via an angular drive, but rather via a spur gear stage 61.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d1865 (Fed. Cir. 2004).

### LIST OF REFERENCE SIGNS

1 Electric machine
3 Manual transmission
5 Spur gear stage
7,9 Gearwheels
10 Transmission housing
11 Differential cage
13 Center differential
15 Center clutch
17 Intermediate shaft
19 Front axle differential
21 Pinion shaft
23 Angular drive
25 Ring gear front axle differential
27 Differential cage front axle
29 Axle bevel gears
31 Compensating gears
33 Front axle propeller shafts
35 Front wheels
39 Cardan shaft
41 Angular drive
43 Ring gear rear axle differential
45 Differential cage
47 Rear axle differential
49 Rear axle propeller shafts
50 Rear axle transmission unit
51 Rear wheels
53 Front axle locking clutch
55 Center locking clutch
57 Rear axle locking clutch
59 Rear axle separating clutch
60 Angular drive
61 Spur gear stage
FR Direction of travel

1.-10. (canceled)

11. A vehicle configured with an all-wheel drive mode, comprising:
a drivetrain which has precisely one electric machine which, in a front-wheel drive in a driving mode, only drives a front axle at a front of the vehicle,
the electric machine is couplable via a center differential and a center clutch with a coupling half couplable to a cardan shaft, which is connectable in terms of drive to rear wheels at a rear of the vehicle via a rear axle differential and via a pair of propeller shafts, and
the rear axle differential is configured to decouple from the drivetrain when the center clutch is open and the rear axle differential is configured to couple to the drivetrain when the center clutch is closed;
a rear axle separating clutch installed in one propeller shaft of the pair of propeller shafts of the rear axle, such that in the front-wheel drive with the center clutch open, the rear axle separating clutch is opened, as a result of which a train section between the center clutch and the rear axle differential is immobilized, and a change from the front-wheel drive to an all-wheel drive during the driving mode can be carried out without interruption of tractive force, and for the change from the front-wheel drive to the all-wheel drive, the center clutch is configured to be closed; and
a rear axle locking clutch configured as a powershiftable multi-plate clutch configured to act in dual functions, such that the rear axle differential is lockable in a locking function of the dual functions via the rear axle locking clutch, and the rear axle locking clutch in a synchronizing clutch function of the dual functions, before the center clutch is closed, carries out a synchronizing operation in which the cardan shaft is accelerated to a rotational speed correlating with a speed of the vehicle such that a coupling half of the center clutch coupled to the cardan shaft is synchronized with the rotational speed of the coupling half of the center clutch coupled to the center differential.

12. The vehicle as claimed in claim 11, wherein, when the locking function is activated, a differential cage of the rear axle differential is coupled to the one propeller shaft of the rear axle to form a rear axle differential lock.

13. The vehicle as claimed in claim 11, wherein after the synchronizing operation has been carried out, in an arbitrary shift sequence the center clutch closes and the rear axle separating clutch closes, and when the center clutch is closed and the rear axle separating clutch is closed, the rear axle locking clutch opens and/or a center locking clutch opens.

14. The vehicle as claimed in claim 11, wherein
the center differential on output sides of the center differential, has an intermediate shaft leading to the rear of the vehicle to the center clutch and a pinion shaft leading to the front of the vehicle to a front axle differential,
the pinion shaft is coupled in terms of drive via the front axle differential and via a pair of front axle propeller shafts to front wheels of the front axle, and
the center differential is lockable via a center locking clutch configured as a powershiftable multi-plate clutch acting in dual functions, such that when a locking function of the dual functions is activated, a differential cage of the center differential is coupled to the pinion shaft leading to the front axle differential to form a center differential lock.

15. The vehicle as claimed in claim 14, wherein the center locking clutch acts in a closed state function of the dual functions, in the front-wheel drive, ensures transmission of driving torque from the center differential to the front axle differential.

16. The vehicle as claimed in claim 14, wherein the electric machine indirectly or directly drives a gearwheel formed on the differential cage of the center differential, by interconnecting a manual transmission and/or a countershaft stage for torque conversion, in a spur gear stage.

17. The vehicle as claimed in claim 14 wherein the front axle differential is lockable via a front axle locking clutch configured as a non-powershiftable dog clutch, such that, when the locking function is activated, a differential cage of the front axle differential is coupled to a front axle propeller shaft of the pair of front axle propeller shafts to form a front axle differential lock.

18. The vehicle as claimed in claim 17, wherein the front-wheel drive is activated in an energy-saving efficiency mode of the vehicle, and/or the all-wheel drive is divided into an on-road mode and into an off-road mode.

19. The vehicle as claimed in claim 18, wherein
in the on-road mode, the rear axle locking clutch, which is configured as a multi-plate clutch, and/or a center locking clutch, which is configured as a multi-plate clutch, are openable and closable in a slip-controlled manner for adjustment of driving dynamics, while the center clutch and the rear axle separating clutch are continuously closed and the front axle locking clutch is open, and
the off-road mode is identical to the on-road mode, except that the front axle locking clutch is closed.
